(19) United States
(12) Patent Application Publication
(10) Pub. No.: US 2007/0285718 A1
(43) Pub. Date: Dec. 13, 2007

(54) Image Processing Device and Method for Moving Device to Ready State

(75) Inventors: Kazuma AOKI, Kasugai (JP); Masashi KATO, Nagoya (JP); Toru TSUZUKI, Okazaki (JP); Hiroyuki YAMAMOTO, Nagoya (JP)

Correspondence Address: BANNER & WITCOFF, LTD.;ATTORNEYS FOR CLIENT NOS. 0166889, 006760, 1100 13th STREET, N.W., SUITE 1200, WASHINGTON, DC, 20005-4051, US

(73) Assignee: BROTHER KOGYO KABUSHIKI KAISHA, Nagoya (JP)

(21) Appl. No.: 11/761,597

(22) Filed: Jun. 12, 2007

(30) Foreign Application Priority Data
Jun. 12, 2006 (JP) 2006162618

(51) Int. Cl. G06K 15/00

(52) U.S. Cl. 358/1.16; 358/474

(57) ABSTRACT

There is provided an image processing device, which comprises an interface into which a removal storage medium can be connected; at least one device having one of an image reading function and an image output function; a preparation control unit configured to execute a preparation process so that the at least one device moves from a first state corresponding to a non-ready state and a second state corresponding to a ready state; and an image process unit having at least one of a function of storing image data and a function of reading image data; a detection unit configured to detect whether the removal storage medium is connected to the interface; and a controller configured to move the at least one device to the second state in response to detection of insertion of the removal medium into the interface by the detection unit.

### CROSS-REFERENCE TO RELATED APPLICATION

This application claims priority under 35 U.S.C. §119 from Japanese Patent Application No. 2006-162618, filed on Jun. 12, 2006. The entire subject matter of the application is incorporated herein by reference.

### BACKGROUND

1. Technical Field

Aspects of the present invention relate to an image processing device supporting a power saving mode to reduce power consumption.

2. Related Art

Devices capable of moving to a power saving mode to reduce power consumption have widely used. Generally, such a device executes a warming up process to move from a power saving state to a ready state. An example of such a device is disclosed in Japanese Patent Provisional Publication No. HEI 9-30079A.

Recently, a printer having an interface to which a removal storage medium can be inserted has been proposed. Such a printer is configured to allow a user to select an image file to be printed from image files stored in the removal storage medium inserted into the interface of the printer.

### SUMMARY

Aspects of the present invention are advantageous in that an image processing device which has an interface, to which a removal storage medium can be inserted, and is capable of reducing a waiting time for moving from a non-ready state to a ready state while achieving low power consumption.

### BRIEF DESCRIPTION OF THE ACCOMPANYING DRAWINGS

FIG. 1 is illustrates an outer appearance of a MFP (Multifunction Function Peripheral) according to an embodiment.

FIG. 2 is a block diagram of the MFP.

FIG. 3A is an example of an internal configuration of a recording unit provided in the MFP if the recording unit is configured as an electrophotographic recording device.

FIG. 3B is another example of an internal configuration of the recording unit if the recording unit is configured as an inkjet recording device.

FIG. 4 is a block diagram of a reading unit provided in the MFP.

FIG. 5 is a plan view of an operation panel provided in the MFP.

FIGS. 6A, 6B and 6C are examples of a screen displayed on a display of the MFP.

FIG. 7 is a table showing a listing of a function and a warm-up process of each components of the MFP.

FIG. 8 is a flowchart illustrating a MFP process executed by the MFP.

FIG. 9 shows a LB printer warm-up process executed by the MFP.

FIG. 10 shows an IJ printer warm-up process executed by the MFP.

FIG. 11 shows a printer mode process executed by the MFP.

FIG. 12 shows a scanner warm-up process executed by the MFP.

FIG. 13 shows a scanner mode process executed by the MFP.

FIG. 14 shows a LB printer release process.

FIG. 15 shows an IJ printer release process.

FIG. 16 shows a scanner release process.

FIG. 17 shows a file search and printer warm-up process according to a second embodiment.

FIG. 18 shows a printable file search process.

FIG. 19 shows a MFP process according to a third embodiment.

FIG. 20 shows a printer mode process according to the third embodiment.

### DETAILED DESCRIPTION

General Overview

It is noted that various connections are set forth between elements in the following description. It is noted that these connections in general and unless specified otherwise, may be direct or indirect and that this specification is not intended to be limiting in this respect. Aspects of the invention may be implemented in computer software as programs storable on computer-readable media including but not limited to RAMs, ROMs, flash memory, EEPROMs, CD-media, DVD-media, temporary storage, hard disk drives, floppy drives, permanent storage, and the like.

According to an aspect of the invention, there is provided an image processing device, which comprises an interface into which a removal storage medium can be connected; at least one device having one of an image reading function and an image output function; a preparation control unit configured to execute a preparation process for the at least one device so that the at least one device moves from a first state where the at least one device is not ready for operation to a second state where the at least one device is ready for operation; and an image process unit having at least one of a function of storing image data corresponding to an image obtained by the image reading function of the at least one device into the removal storage medium connected to the interface, and a function of reading image data from the removal medium connected to the interface and passing the read image data to the at least one device so that an image corresponding to the read image data is outputted by the image output function of the at least one device. Further, the image processing device comprises a detection unit configured to detect whether the removal storage medium is connected to the interface; and a controller configured to cause the preparation control unit to move the at least one device to the second state in response to detection of insertion of the removal medium into the interface by the detection unit.

With this configuration, the preparation process is started for the device when the insertion of the removal medium to the interface is detected. Such a configuration makes it possible to reduce waiting time from activation of the device to the ready state (second state) while achieving energy-saving.

In at least one aspect, the at least one device comprises a device having the image reading function and a device having the image output function, and the image processing device further comprises a selection unit configured to select one of the at least one device to be moved to the second state. In this case, the controller causes the preparation control unit to move a device selected by the selection unit to the second state in response to detection of insertion of the removal medium into the interface by the detection unit.

Since only the selected device is moved to the ready state, consumption of power or ink can be minimized.

In at least one aspect, the selection unit selects one of the at least one device based on a status of the device having the image reading function.

In at least one aspect, the selection unit selects the device having the image output function if the removal storage medium connected to the interface has a predetermined type of data.

Such a configuration makes it possible to predict a device to be used in accordance with a type of data stored in the removal storage medium, and to execute the preparation process in accordance with the prediction. Therefore, it is possible to considerably reduce the waiting time from the activation of the device to the ready state of the device while keeping the consumption of the power or ink at a minimum level.

In at least one aspect, the removal storage medium is accessible through a file system having a directory structure, and the image processing device comprises a directory designation unit configured to designate a directory of the removal storage medium to be accessed. In this case, the selection unit selects the device having the image output function if a designated directory of the removal storage medium designated by the directory designation unit has a predetermined type of data.

Such a configuration makes it possible to predict a device to be used in accordance with a type of data stored in a directory of the removal storage medium, and to execute the preparation process in accordance with the prediction. Therefore, it is possible to considerably reduce the waiting time from the activation of the device to the ready state of the device while keeping the consumption of the power or ink at a minimum level.

In at least one aspect, the device having the image output function is a recording device configured to record an image on a recording medium. In this case, the selection unit selects the recording device as a device to be moved to the second state.

Such a configuration makes it possible to cause the recording device to execute the preparation process if it is predicted that the recording device is to be used. For example, the recording device is caused to execute the preparation process if the removal storage medium or a directory in the removal storage medium has a printable file.

In at least one aspect, the at least one device has at least the image output function, and the at least one device having the image output function is an electrophotographic recording device configured to form an image on a recording medium by forming firstly a toner image on the recording medium and then heat fixing the toner image through a fixing unit. In this case, the preparation control unit executes the preparation process for the electrophotographic recording device by heating the fixing unit to have a predetermined temperature if the electrophotographic recording unit is in the first state where the fixing unit is not at the predetermined temperature.

Such a configuration makes it possible to cause the electrophotographic recording device to execute the preparation process in which the fixing unit is heated to have the predetermined temperature, in response to insertion of the removal storage medium into the interface.

In at least one aspect, the at least one device has at least the image output function, and the at least one device having the image output function is an inkjet recording device configured to form an image on a recording medium by ejecting ink fro nozzles. In this case, the preparation control unit executes the preparation process for the inkjet recording device by cleaning the nozzles if the inkjet recording device is in the first state where the nozzles have not been cleaned.

Such a configuration makes it possible to cause the inkjet recording device to execute the preparation process in which nozzles are cleaned, in response to insertion of the removal storage medium into the interface.

In at least one aspect, the image processing device further comprises an original detection unit configured to detect presence or absence of an original on which an image to be read is formed, and the device having the image reading function is an image reading device configured to read an image from the original. In this case, the selection unit selects the image reading device as a device to be moved to the second state if the original detection unit detects that the original is present.

Such a configuration makes it possible to warm-up the image reading device in response to insertion of the removal storage medium into the interface.

In at least one aspect, the at least one device has at least the image reading function, and the at least one device having the image reading function is an image reading device configured to read information from a target by illuminating the target using a lamp and then obtaining the information based on light reflected from the target. In this case, the preparation control unit executes the preparation process for the image reading device by waiting until an amount of light of the lamp is stabilized from activation of the lamp if the image reading device is in the first state where the lamp is off or the amount of light of the lamp is not stabilized.

Such a configuration makes it possible to warm-up the image reading device so that the amount of light of the lamp is stabilized, in response to insertion of the removal storage medium into the interface.

In at least one aspect, the image processing device further comprises a releasing unit configured to execute a release process for the at least one device so that the at least one device moves from the second state to the first state. In this case, the controller causes the releasing unit to move the at least one device to the first state in response to completion of an operation of the at least one device.

In at least one aspect, the image processing device further comprises a releasing unit configured to execute a release process for the at least one device so that the at least one device moves from the second state to the first state. In this case, the controller causes the releasing unit to move the at least one device to the first state in response to detection of disconnection of the removal storage medium from the interface by the detection unit.

According to another aspect of the invention, there is provided a method for warming-up an image processing device including at least one device having one of an image reading function and an image output function. The method comprises a detecting step of detecting whether a removal storage medium is connected to an interface of the image processing device, and a preparation step of moving the at least one device from a first state where the at least one device is not ready for operation to a second state where the at least one device is ready for operation, in response to detection of insertion of the removal medium into the interface.

With this configuration, the preparation process is started for the device when the insertion of the removal medium to the interface is detected. Such a configuration makes it possible to reduce waiting time from activation of the device to the ready state (second state) while achieving energy-saving.

In at least one aspect, the at least one device comprises a device having the image reading function and a device having the image output function. The method further comprises a selection step of selecting one of the at least one device to be moved to the second state. In the preparation step, the device selected by the selection step is moved to the second state in response to detection of insertion of the removal medium into the interface.

Since only the selected device is moved to the ready state, consumption of power or ink can be minimized.

In at least one aspect, in the selection step, one of the at least one device is selected based on a status of the device having the image reading function.

In at least one aspect, in the selection step, the device having the image output function is selected if the removal storage medium connected to the interface has a predetermined type of data.

Such a configuration makes it possible to predict a device to be used in accordance with a type of data stored in the removal storage medium, and to execute the preparation process in accordance with the prediction. Therefore, it is possible to considerably reduce the waiting time from the activation of the device to the ready state of the device while keeping the consumption of the power or ink at a minimum level.

In at least one aspect, the removal storage medium is accessible through a file system having a directory structure. The method further comprises a directory designation step of to designating a directory of the removal storage medium to be accessed. In the selection step, the device having the image output function is selected if a designated directory of the removal storage medium has a predetermined type of data.

Such a configuration makes it possible to predict a device to be used in accordance with a type of data stored in a directory of the removal storage medium, and to execute the preparation process in accordance with the prediction. Therefore, it is possible to considerably reduce the waiting time from the activation of the device to the ready state of the device while keeping the consumption of the power or ink at a minimum level.

In at least one aspect, the device having the image output function is a recording device configured to record an image on a recording medium. In the selection step, the recording device is selected as a device to be moved to the second state.

Such a configuration makes it possible to cause the recording device to execute the preparation process if it is predicted that the recording device is to be used. For example, the recording device is caused to execute the preparation process if the removal storage medium or a directory in the removal storage medium has a printable file.

In at least one aspect, the at least one device has at least the image output function, and the at least one device having the image output function is an electrophotographic recording device configured to form an image on a recording medium by forming firstly a toner image on the recording medium and then heat fixing the toner image through a fixing unit. In this case, the preparation step comprises a step of heating the fixing unit to have a predetermined temperature if the electrophotographic recording unit is in the first state where the fixing unit is not at the predetermined temperature.

Such a configuration makes it possible to cause the electrophotographic recording device to execute the preparation process in which the fixing unit is heated to have the predetermined temperature, in response to insertion of the removal storage medium into the interface.

In at least one aspect, the at least one device has at least the image output function, and the at least one device having the image output function is an inkjet recording device configured to form an image on a recording medium by ejecting ink fro nozzles. In this case, the preparation step comprises a step of cleaning the nozzles if the inkjet recording device is in the first state where the nozzles have not been cleaned.

Such a configuration makes it possible to cause the inkjet recording device to execute the preparation process in which nozzles are cleaned, in response to insertion of the removal storage medium into the interface.

In at least one aspect, the method further comprises an original detection step of detecting presence or absence of an original on which an image to be read is formed. The device having the image reading function is an image reading device configured to read an image from the original. In the selection step, the image reading device is selected as a device to be moved to the second state if the presence of the original is detected by the original detection step.

Such a configuration makes it possible to warm-up the image reading device in response to insertion of the removal storage medium into the interface.

In at least one aspect, the at least one device has at least the image reading function, and the at least one device having the image reading function is an image reading device configured to read information from a target by illuminating the target using a lamp and then obtaining the information based on light reflected from the target. The preparation step comprises a step of waiting until an amount of light of the lamp is stabilized from activation of the lamp if the image reading device is in the first state where the lamp is off or the amount of light of the lamp is not stabilized.

Such a configuration makes it possible to warm-up the image reading device so that the amount of light of the lamp is stabilized, in response to insertion of the removal storage medium into the interface.

In at least one aspect, the method further comprises a releasing step of moving the at least one device from the second state to the first state in response to completion of an operation of the at least one device.

In at least one aspect, the method further comprises a releasing step of moving the at least one device from the second state to the first state in response to detection of disconnection of the removal storage medium from the interface.

According to another aspect of the invention, there is provided a computer readable medium having computer readable instruction stored thereon, which, when executed by a processor of an image processing device including at least one device having one of an image reading function and an image output function, configures the processor to perform the steps of: detecting whether a removal storage medium is connected to an interface of the image processing device; and moving the at least one device from a first state where the at least one device is not ready for operation to a second state where the at least one device is ready for operation, in response to detection of insertion of the removal medium into the interface.

With this configuration, the preparation process is started for the device when the insertion of the removal medium to the interface. Such a configuration makes it possible to reduce waiting time from activation of the device to the ready state (second state) while achieving energy-saving.

### EMBODIMENT

Hereafter, embodiments according to the invention will be described with reference to the accompanying drawings.

### First Embodiment

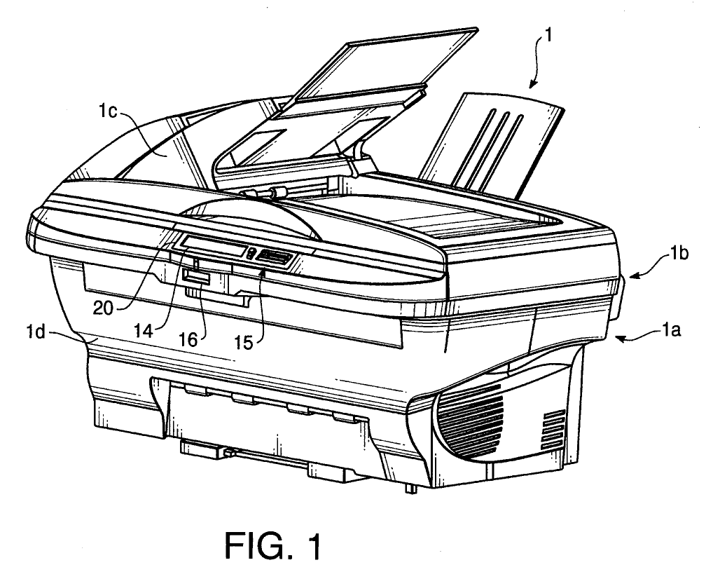

FIG. 1 is illustrates an outer appearance of a MFP (Multifunction Function Peripheral) 1 according to an embodiment. The MFP 1 functions as an image processing device. As shown in FIG. 1, the MFP 1 includes a lower body 1a and an upper body 1b which is openable and closable with respect to the lower body 1a. That is, the MFP 1 has a clam shell structure. In the upper body 1b, an image reading 1c is provided. In the lower body 1a, an image forming device 1d is provided.

At the front side portion on an upper surface of the MFP 1, an operation panel 20 including a display 14 and an operation unit 15 is provided. In the front surface of the MFP 1, a USB host interface 16 to which a USB memory (i.e., a removal storage medium) can be detachably inserted is provided. The MFP 1 has a file system configured to mount the USB memory inserted into the USB host interface 16 as a directory so that files in stored in the USB host interface can be read from and can be written onto the USB memory through the file system.

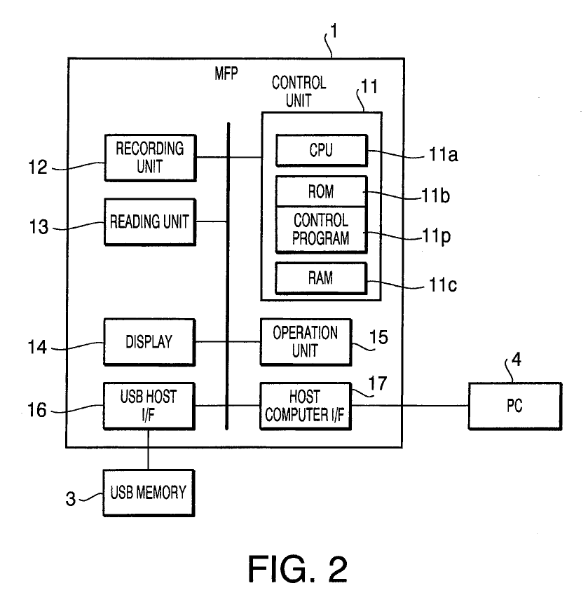

FIG. 2 is a block diagram of the MFP 1. As shown in FIG. 1, the MFP 1 includes a control unit 11, a recording unit 12, a reading unit 13, the display 14 such as an liquid crystal display, the operation unit 15 including operation keys, the USB host interface 16 to which a USB memory 3 can be inserted, and a host computer interface 17 through which a personal computer can be connected to the MFP 1. The operation unit 11 includes a CPU 11a, a ROM 11b, and a RAM 11c. In the ROM 11b, various types of control programs p are stored. By executing the control programs p, various functions of the MFP 1 can be achieved. The reading unit 12 has the function of printing images on recording medium by an electrophotographic process or an inkjet printing process. The reading unit 13 forms the image reading device 1c.

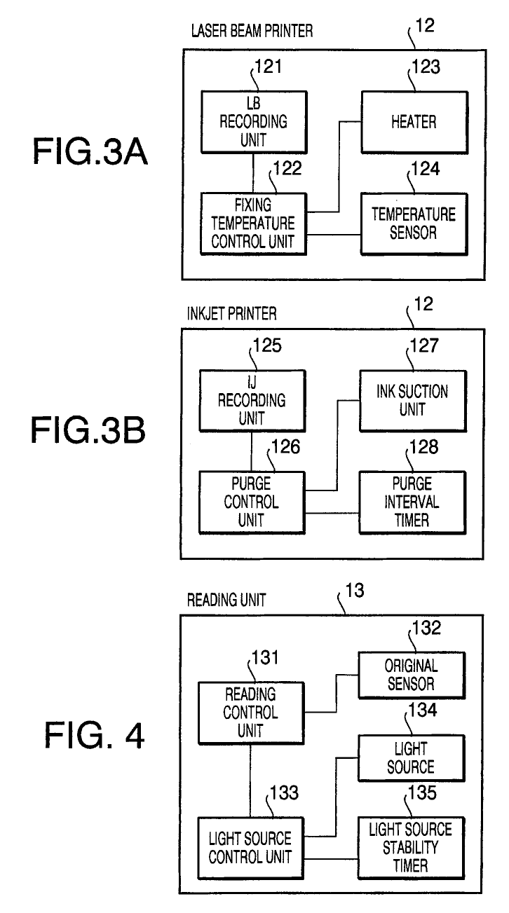

FIG. 3A is an example of an internal configuration of the recording unit 12. In this example, the recording unit 12 is configured as an electrophotographic recording device (i.e., a laser beam printer) which operates to from a toner image on a recording medium and to fix the toner mage on the recording medium through use of a heat fixing unit. In this case, the recording unit 12 includes a LB (Laser Beam) recording unit 121 configured to control the operation of the recording unit 12, a fixing temperature control unit 122 configured to control the temperature of the fixing unit, a heater 123 used to increase the temperature of the fixing unit, and a temperature sensor 124 used to measure the temperature of the fixing unit. Each of the heater 123 and the temperature sensor 124 is controlled by the fixing temperature control unit 122. The recording unit includes a recording mechanism (not shown).

FIG. 3B is another example of an internal configuration of the recording unit 12. In this example, the recording unit 12 is configured as an inkjet recording device (i.e., an inkjet printer) which operates to eject ink from an inkjet head (nozzles) and to from an image on a recording medium. In this case, the recording unit 12 includes an IJ (Ink Jet) recordation control unit 125 configured to control the operation of the recording unit 12, a purge control unit 126 configured to clean the inkjet head, an ink suction unit 127 configured to suck ink from the inkjet head under control of the purge control unit 126, and a purge interval timer 128 configured to measure a time interval from execution of the previous cleaning operation.

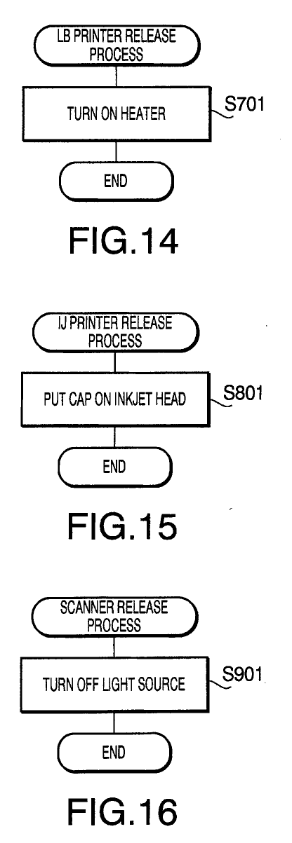

FIG. 4 is a block diagram of the reading unit 13. The reading unit 13 is configured as a scanner which operates to illuminate an original and to read information from the original based on light reflected from the original. As shown in FIG. 14, the reading unit 13 includes a reading control unit 131 configured to control the operation of the reading unit 13, an original sensor 132 used to detect whether an original is placed on an original base, a light source control unit 133 configured to control a light source 134, the light source 134 for illuminating an original under control of the light source control unit 133, a light source stability timer 135 used to measure time from the time when the light source is activated to the time when the light amount of the light source 134 is stabilized. The light source control unit 133 includes a power supply for supplying power to the light source 134.

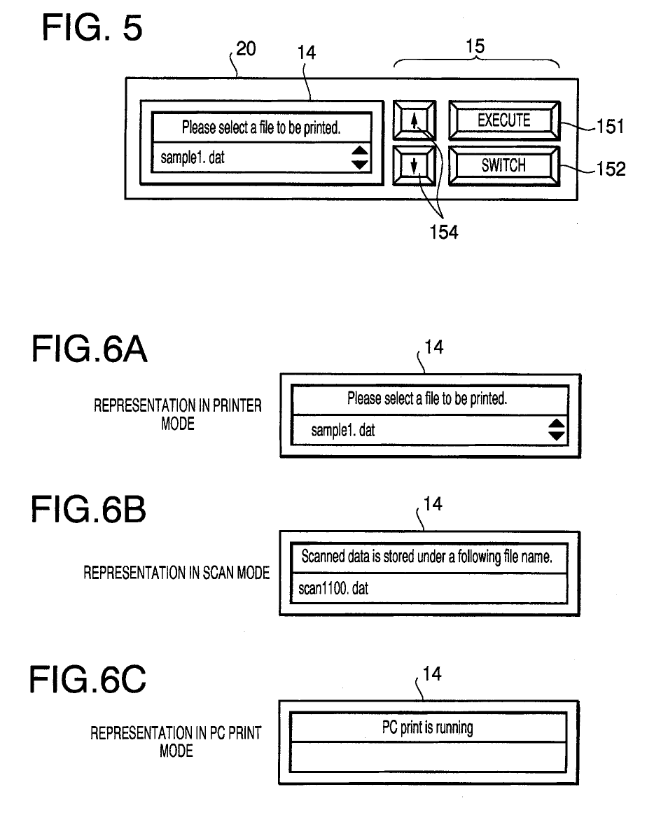

FIG. 5 illustrates a front view of the operation panel 20. As shown in FIG. 5, the operation panel 20 includes the display 14 (i.e., the liquid crystal display), and the operation unit 15 having an execution key 151, a switch key 152, and cursor keys 154. The operation panel 20 has an integrated structure of the display 14 and the operation unit 15. The execution key 151 is used to print a selected file through the recording unit 12. the switch key 152 is used to switch between a printer mode and a scan mode. The cursor keys 154 are used to move a cursor to select an item from among items displayed on the display 14.

FIGS. 6A, 6B and 6C are examples of a screen displayed on the display 14. FIG. 6A is a screen displayed in the printer mode. On the screen shown in FIG. 6A, it is possible to select a file to be printed by operating the cursor keys 154. The control program 11p creates a file name, for example, by adding a serial number and an extension “.dat” to the rear of a word “scan”. The printer mode is an operation mode in which a file selected by a user through the operation panel 20 is read from a USB memory 3 and an image corresponding to the selected file is printed through the recording unit 12.

Through the screen in the scan mode (FIG. 6B), the user is able to recognize a file name of scanned data. The scan mode is an operation mode in which a file of an image obtained by the reading unit 13 is generated and the generated file is stored in the USB memory 3.

FIG. 6C shows an example of a screen in a PC print mode. Through the screen in the PC print mode, the user is able to recognize that the MFP 1 is in the PC print mode. The PC print mode is an operation mode in which the MFP 1 receives a file from a PC (Personal computer) 4, which is connected to the MFP 1 through the host computer interface 17 and print an image corresponding to the received file on a sheet of paper.

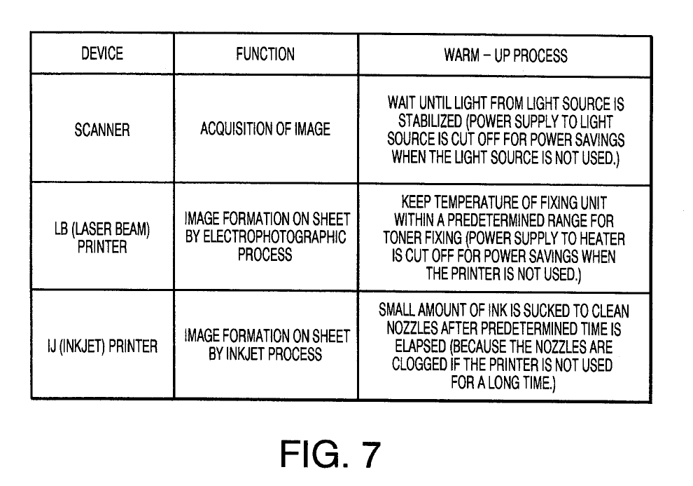

FIG. 7 is a table showing a listing of a function and a preparation process (hereafter, referred to as a warm-up process) of each components of the MFP 1. As shown in FIG. 7, the reading unit 13 cuts off the power supply to the light source 134 for power savings when the reading unit 13 is not used. It is not possible to obtain stable image acquisition performance immediately after the power supply to the light source 134. That is, it is required to wait until a predetermined time is elapsed from the time when the light source 134 is activated so that image acquisition performance of the reading unit 13 is stabilized. The reason is that in order to obtain stable image acquisition performance, the amount of light emitted from the light source 134 have to be stabilized. For this reason, the warm-up process for the reading unit 13 is executed by monitoring the lapse of time from the activation of the light source 134 through use of the light source stability timer 135 to detect the lapse of the predetermined time. In other words, the warm-up process for the reading unit 13 is a process where the MFP 1 waits until the predetermined time is elapsed. Hereafter, the state where the light source 134 is not supplied power is referred to as a non-ready state, and the state where the amount of light of the light source 134 is stabilized is referred to as a ready-state. The transition time period from the activation of the light source 134 to the stabilized state of the light amount of the light source 134 is also regarded as the non-ready state.

As shown in FIG. 7, if the recording unit 14 is configured as a laser beam printer, the recording unit 14 cuts off the power supply to the heater 123 for power savings when the laser beam printer is not used. In the laser beam printer, an image is formed on a sheet of paper in accordance with an electrophotographic process where a toner image is developed on a sheet and then the image is fixed by a fixing unit which applies heat and pressure to the sheet. Regarding such an electrophotographic process, stable imaging quality can not be achieved at the time immediately after the activation of the heater 123. That is, it is required to wait until the temperature of the heater 123 reaches a predetermined value. The warm-up process for the laser beam printer is a process for activating the heater 123 and waiting until the temperature of the heater 123 reaches the predetermined value.

A state where the heater 123 is not supplied with power corresponds to the non-ready state, while a state where the temperature of the heater 123 is at the predetermined value corresponds to the ready state. A time period from the activation of the heater 123 to the time where the temperature of the heater 123 reaches the predetermined value is also regarded as the non-ready state.

As shown in FIG. 7, if the recording unit 14 is configured as an inkjet printer, it is required to prevent the nozzles of the inkjet head from being clogged with dry ink because if the nozzles are clogged with dry ink, the quality of the image on the sheet is badly affected. Therefore, such an inkjet printer requires the condition where the nozzles are not clogged with dry ink. The possibility of occurrence of such a problem (clogging of nozzles) may increase as an interval where the inkjet head is not used increases. Therefore, such an inkjet printer is configured to execute a purge process for sucking ink from the inkjet head if the inkjet printer judges that an interval where the inkjet printer is not used reaches a predetermined ling time. In such a purge process, it is also required to minimize the amount of ink sucked in the purge process because the sucked ink can not be used for the formation of images and is discarded, even though the amount of purged ink is very small.

For this reason, the recording unit 12 (i.e., the inkjet printer) executes the warm-up process where the inkjet head is cleaned if it is judged that a predetermined time is elapsed from the previous purge process. Such a lapse of time from the previous purge process is obtained through the purge interval timer 128. Regarding the inkjet printer, the non-ready state corresponds to a state where the inkjet head is not cleaned, while the ready state corresponds to a state where the inkjet head is cleaned. The recording unit 12 (inkjet printer) does not use the lapse of time from the previous printing operation because in the printing operation all of the ink types (ink colors) are not necessarily used. The recording unit 12 further operates to put a cap on the inkjet head when the inkjet head is not used so that the inkjet head is prevented from being dried. Therefore, the warm-up process for the inkjet printer also includes a process for removing the cap from the inkjet head.

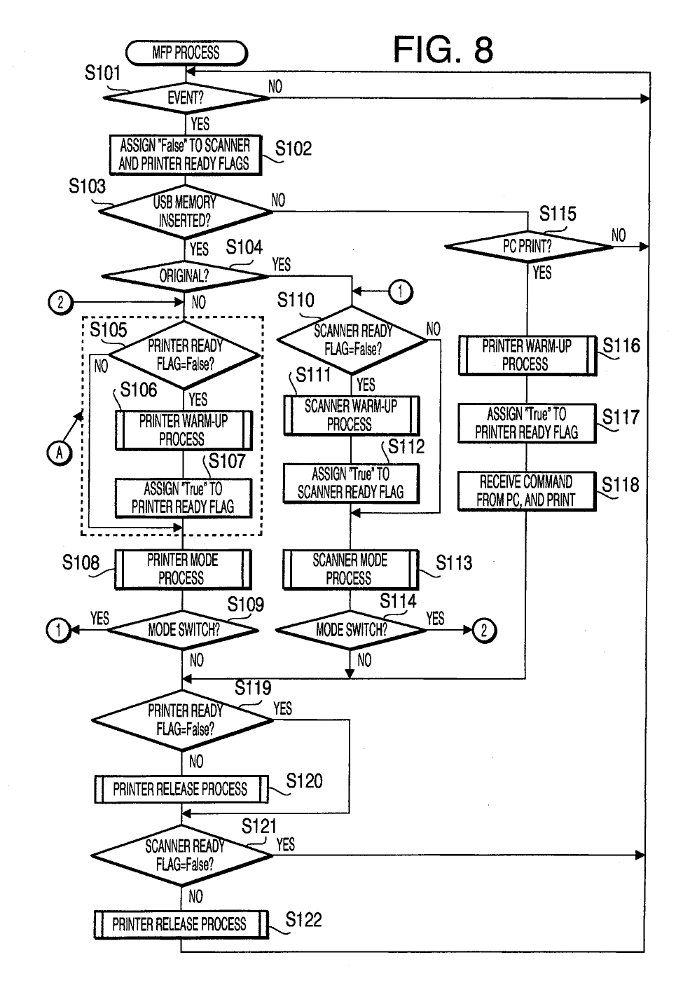

Hereafter, operations of the MFP 1 are explained. FIG. 8 is a flowchart illustrating a MFP process executed under control of the control unit 11 of the MFP 1. When the MFP process is initiated, the control unit 11 judges whether an event (i.e., an instruction to be handled by the MFP 1) is received (step S101). The control unit 11 waits until an event is detected (S101: NO). If an event is detected (S101: YES), the control unit 11 changes a value of each of a scanner ready flag and a printer ready flag to “False” (step S102). Then, the control unit 11 judges whether the event corresponds to insertion of the USB memory 3 into the USB host interface 16 (step S103).

The scanner ready flag indicates whether the warm-up process for the reading unit 13 has been conducted. The printer ready flag indicates whether the warm-up process for the recording unit 12 has been conducted. For each of the scanner ready flag and the printer ready flag, the value “False” means that the warm-up process has not been conducted, while the value “True” means that the warm-up process has been conducted.

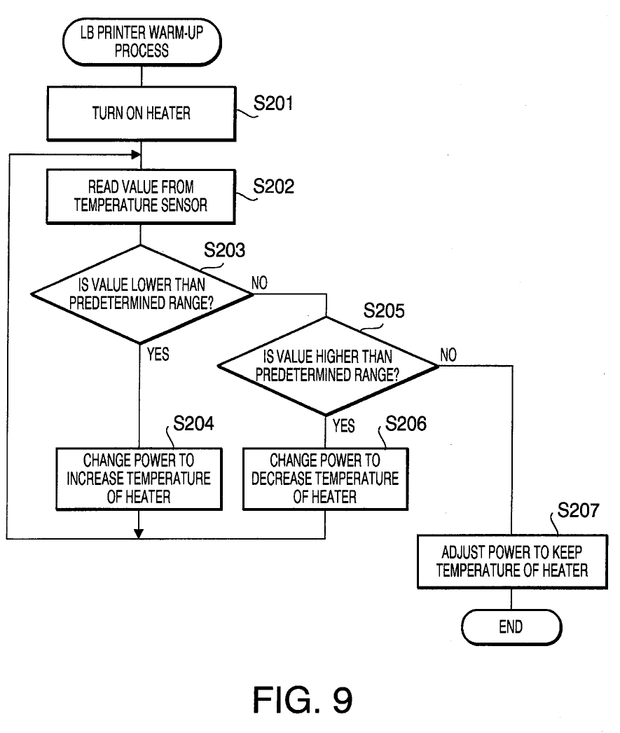

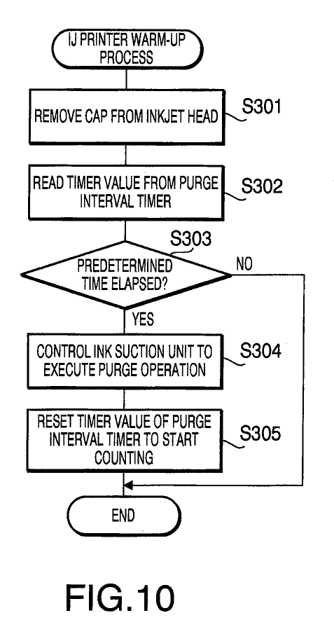

If the event corresponds to the insertion of the USB memory 3 into the USB host interface 16 (S103: YES), the control unit 11 judged whether an original is placed on an original base of the reading unit 13 (step S104). If no original is placed (S103; NO), the control unit judges that the current mode is the printer mode and judges whether the printer ready flag is “False” (step S105). If the printer ready flag is not “False” (S105: NO), control proceeds to step S108. If the printer ready flag is “False” (S105: YES), control proceeds to step S106 where the control unit 11 executes a LB printer warm-up process (see FIG. 9) or an IJ printer warm-up process (see FIG. 10).

If the recording unit 12 is configured as a laser beam printer, the LB printer warm-up process is executed. FIG. 9 shows the LB printer warm-up process executed under control of the control unit 11. As shown in FIG. 9, when the LB printer warm-up process is initiated, the heater 123 is activated under control of the fixing temperature control unit 122 (step S201). Then, the temperature is read from the temperature sensor 124 under control of the temperature control unit 122 (step S123). If the measured temperature is lower than a predetermined temperature range (S203: YES), the power to the heater 123 is changed to a higher level to increase temperature under control of the temperature control unit 122 (step S204). Then, control returns to step S202.

If the temperature is not lower than the predetermined temperature range (S203: NO), the control unit 11 judges whether the measured temperature is higher than the predetermined temperature range (step S205). If the measured temperature is higher than the predetermined temperature range (S205: YES), power to the heater 123 is changed to a lower level to decrease temperature under control of the temperature control unit 122 (step S206). Then, control returns to step S202. If the measured temperature is not higher than the predetermined temperature range (S205: NO), control proceeds to step S207 where the power to the heater 123 is changed to a level to maintain the current temperature under control of the temperature control unit 122. Then, the LB printer warm-up process terminates.

If the recording unit 12 is configured as an inkjet printer, the IJ printer warm-up process is executed. FIG. 10 shows the IJ printer warm-up process executed under control of the control unit 11. As shown in FIG. 10, when the IJ printer warm-up process is initiated, the control unit 11 releases the cap of the inkjet head (step S301). Then, the control unit 11 reads a value of the purge interval timer 128 (S302).

Next, the control unit 11 judges whether a predetermined time has elapsed from the previous purge process (step S303). The predetermined time is, for example, a few weeks or a few months. If the predetermined time is not elapsed (S303: NO), the IJ printer warm-up process terminates. If the predetermined time is elapsed (S303: YES), the nozzles of the inkjet head is purged by the ink suction unit 127 under control of the purge control unit 126 (step S304). Then, a count of the purge interval timer 128 is reset to start counting of the lapse of time again (step S305). Then, the IJ printer warm-up process terminates.

After the IJ printer warm-up process or the LB printer warm-up process is finished, control returns to the MFP process. In this case, the control unit 11 assigns “True” to the printer ready flag (step S107). Then, control proceeds to step S108 where the control unit 11 executes a printer mode process.

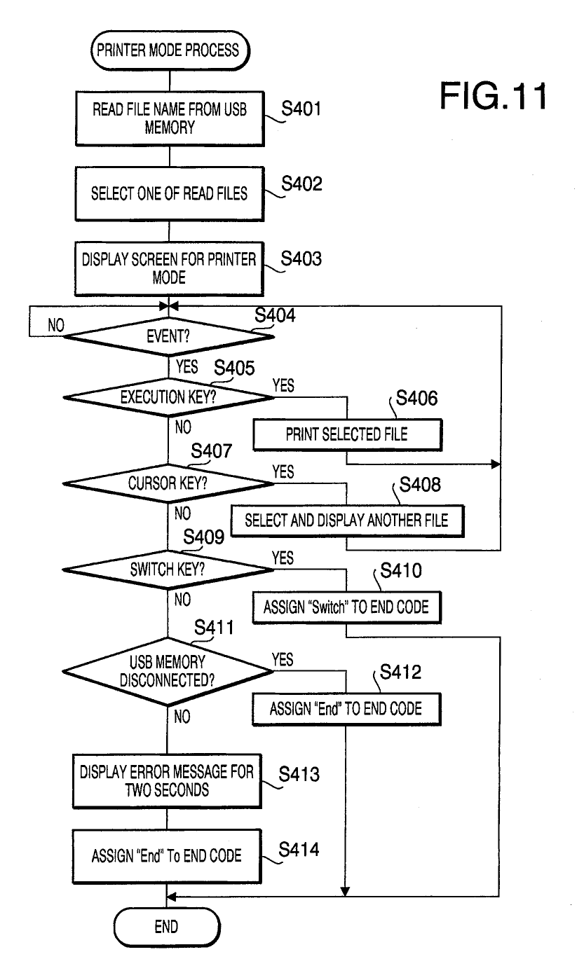

FIG. 11 shows the printer mode process executed under control of the control unit 11. In the printer mode process, the control unit 11 reads file names from the USB memory 3 (step S401). One of the file names read from the USB memory 3 is selected (step S402). For example, a file name firstly detected on the USB memory 3 is selected. Next, the control unit 11 displays information that the MFP 1 is in the printer mode as shown in FIG. 6A (step S403).

Next, the control unit 11 judges whether an event (e.g., an interruption) occurs (step S404). The control unit 11 waits until an event occurs (S404: NO). If an event occurs (S404: YES), the control unit 11 judges whether the event corresponds to pressing of the execution key 151 (step S405). If the event corresponds to the pressing of the execution key 151 (S405: YES), the image corresponding to the selected file (i.e., the file currently displayed on the display 14) is printed through the recording unit 12 (step S406). Then, control returns to step S404. In step S406, the control unit 11 may print words “print impossible” on a sheet of paper if the selected file is an unprintable file.

If the event does not correspond to the pressing of the execution key 151 (S405: NO), the control unit 11 judges whether the event corresponds to pressing of the cursor key 154 (step S407). If the event corresponds to the pressing of the cursor key 154 (S407: YES), the control unit 11 displays another file on the display 14 as a candidate (step 408). Then, control returns to step S404. Assuming that the file names are arranged in order where the files are found in the USB memory 3, the control unit 11 selects a file placed at the rear of the current point in the arrangement of the files if the downward arrow cursor key 154 is pressed, while the control unit 11 selects a file placed at the front of the current point in the arrangement of the files if the upward arrow cursor key 154 is pressed.

If the upward cursor key 154 is pressed in the state whether the top file placed at the top in the arrangement of the files is selected, the file placed at the bottom in the arrangement of the files is selected. If the downward cursor key 154 is pressed in the state whether the bottom file placed at the bottom in the arrangement of the files is selected, the file placed at the top in the arrangement of the files is selected.

If the event does not correspond to the pressing of the cursor key 154 (S407: NO), control proceeds to step S409 where the control unit 11 judged whether the event corresponds to pressing of the switch key 152. If the event corresponds to the pressing of the switch key 152 (S409: YES), the control unit 11 assigns a value “Switch” to an end code (step S410). Then, the printer mode process terminates.

If the event does not correspond to the pressing of the switch key 152 (S409: NO), the control unit 11 judges whether the event corresponds to removal of the USB memory 3 from the USB host interface 16 (step S411). If the event corresponds to the removal of the USB memory 3 from the USB host interface 16 (S411: YES), the control unit 11 assigns “End” to the end code (step S412). Then, the printer mode process terminates.

If the event does not correspond to the removal of the USB memory 3 from the USB host interface 16 (S411: NO), the control unit 11 displays an error message on the display 14 for two seconds (step S413). Next, the control unit 11 assigns “End” to the end code (step S414). Then, the printer mode process terminates.

After control returns from the printer mode process to the MFP process, the control unit 11 judges whether the operation mode should be changed based on whether the “Switch” is assigned to the end code (step S109 in FIG. 8). If the mode switch is required (S109: YES), control proceeds to step S110. If the mode switch is not required (i.e., if “End” is assigned to the end code) (S109: NO), control proceeds to step S119.

In step S110, the control unit judges whether “False” is assigned to the scanner ready flag (step S110). If the scanner ready flag is not “False” (S110: NO), control proceeds to step S113. If the scanner ready flag is “False” (S110: YES), the control unit 11 executes a scanner warm-up process (step S11).

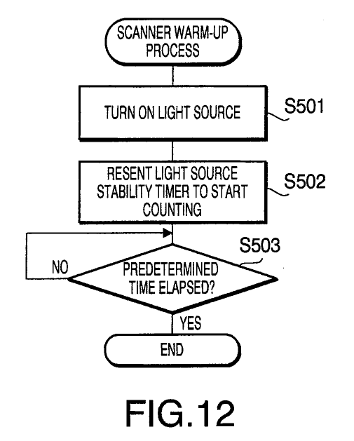

FIG. 12 shows the scanner warm-up process. When the scanner warm-up process is initiated, power is supplied to the light source 134 under control of the light source control unit 133 (step S501). Then, the light source stability timer 135 is reset to start counting up of time (step S502). Next, the control unit 11 judges whether a predetermined time, within which the amount of light of the light source 134 is stabilized, is elapsed (step S503).

If the control unit 11 waits until the predetermined time is elapsed (S503: NO). If the predetermined time is elapsed (S503: YES), the scanner warm-up process terminates.

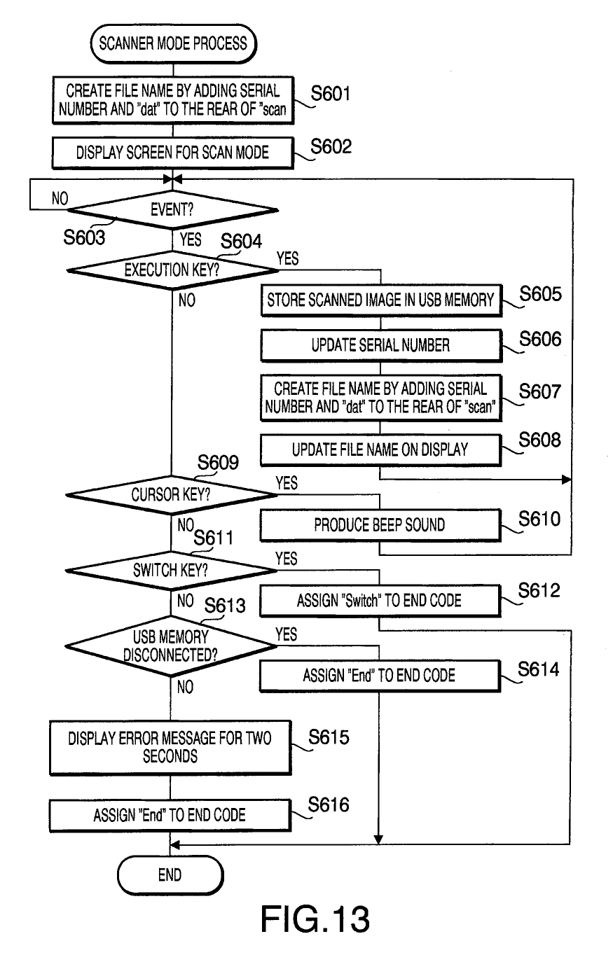

After control returns from the scanner warm-up process to the MFP process, the control unit 11 assigns “True” to the scanner ready flag (step S112). Then, the control unit 11 executes a scanner mode process (step S113). FIG. 13 shows a flowchart of the scanner mode process.

When the scanner mode process is initiated, the control unit 11 creates a file name by adding a serial number and an extension “.dat” to the rear of words “scan” (step S601). The serial number is incremented each time an image obtained by the scanner operation is stored in the USB memory 3 as a file. Then, the control unit 11 displays a screen indicating the scanner mode on the display 14 as shown in FIG. 6B (step S602). Then, the control unit 11 judges whether an event (e.g., an interruption) occurs (step S603). The control unit 11 waits until an event occurs (S603: NO).

If an event is detected (S603: YES), the control unit judges whether the event corresponds to pressing of the execution key 151 (step S604). If the event corresponds to the pressing of the execution key 151 (S604: YES), the control unit 11 stores a file, which is obtained by the reading unit 13, in the USB memory 3 (step S605). Next, the control unit 11 updates the serial number by incrementing the serial number (step S606). Then, the control unit 11 creates a file name, for example, by adding the serial number and an extension “.dat” to the rear of words “scan” (step S607).

Next, the control unit 11 renews the file name on the display 14 (step S608). Then, control returns to step S603. If the event does not correspond to the pressing of the execution key 151 (S604: NO), the control unit 11 judges whether the event corresponds to pressing of the cursor key 154 (step S609). If the event corresponds to pressing of the cursor key 154 (S609: YES), the control unit 11 controls a beeper (not shown) to produce beep sound (step S610). Then, control returns to step S603.

If the event does not correspond to pressing of the cursor key 154 (S609: NO), control unit 11 judges whether the event corresponds to pressing of the switch key 152 (step S611). If the event corresponds to pressing of the switch key 152 (S611: YES), the control unit 11 assigns “Switch” to the end code (step S612). Then, the scanner mode process terminates.

If the event does not correspond to pressing of the switch key 152 (S611: NO), the control unit 11 judges whether the event corresponds to removal of the USB memory 3 from the USB host interface 16 (step S613). If the event corresponds to the removal of the USB memory 3 from the USB host interface 16 (S613: YES), the control unit 11 assigns “End” to the end code (step S614). Then, the scanner mode process terminates.

If the event does not correspond to the removal of the USB memory 3 from the USB host interface 16 (S613: NO), the control unit 11 displays an error message on the display 14 for two seconds (step S615). Next, the control unit 11 assigns “End” to the end code (step S616). Then, the scanner mode process terminates.

After control returns to the MFP process from the scanner mode process, the control unit 11 judges whether the operation mode should be changed based on whether the “Switch” is assigned to the end code (step S114 in FIG. 8). If the mode switch is required (S114: YES), control proceeds to step S105. If the mode switch is not required (S114: NO), control proceeds to step S119.

If it is judged in step S103 that the event does not correspond to the insertion of the USB memory 3 into the USB host interface 16 (S103: NO), the control unit 11 judges whether the event corresponds to a print request from the PC 4 (i.e., a PC print operation) (step S115). If the event does not correspond to the PC print operation (S115: NO), control returns to step S101. If the event corresponds to the PC print operation (S115: YES), the control unit 11 executes the IJ printer warm-up process or the LB printer warm-up process depending on the type of the recording unit 12 (step S116).

After step S116 is processed, the control unit 11 assigns “True” to the printer ready flag (step S117). Then, the control unit 11 controls the recording unit 12 to print an image corresponding to a command from the PC 4 (step S118). Then, control proceeds to step S119.

In step S119, the control unit 11 judges whether the printer ready flag is “False”. If the printer ready flag is not “False” (S119: NO), the control unit 11 executes an IJ printer release process or an LB printer release process depending on the type of the recording unit 12 (step S120). If the printer ready flag is “False” (S1119: YES), control proceeds to step S121 without processing step S120.

FIG. 14 shows the LB printer release process. In the LB printer release process, the heater 123 is switched to off under control of the fixing temperature control unit 122 (step S701). Then, the LB printer release process terminates.

FIG. 15 shows the IJ printer release process. In the IJ printer release process, the control unit 11 controls the ink suction unit 127 to put the cap on the nozzles of the inkjet head (step S801). Then, the IJ printer release process terminates.

After the LB printer release process or the IJ printer release process is finished, the control unit 11 judges whether the scanner ready flag is “False” (step S121). If the scanner ready flag is not “False” (S121: NO), the control unit 11 executes a scanner release process (step S122). If the scanner ready flag is “False” (S121: YES), control returns to step S101 without processing step S122.

FIG. 16 shows the scanner release process. In the scanner release process, the light source 134 is switched to off under control of the light source control unit 133 (step S901). Then, the scanner release process terminates.

After the scanner release process is finished, control returns to step S101 in the MFP process.

According to the above mentioned first embodiment, the MFP 1 starts the warm-up process for the recording unit 12 or the reading unit 13 when the USB memory 3 is inserted into the USB host interface 16. That is, the warm-up process for the recording unit 12 or the reading unit 13 is executed before a command requesting use of the recording unit 12 or the reading unit 13 is directly inputted by the user to the MFP 1. Such a configuration makes it possible to reduce the waiting time from the activation of the recording unit 12 (the reading unit 13) to the ready state of the recording unit 12 (the reading unit 13).

Since the MFP 1 selects an appropriate device from the recording unit 12 and the reading unit 13 in accordance with presence or absence of an original to be scanned, it is possible to avoid an unnecessary warm-up process from being executed for a device which the user does not want to use. Therefore, the MFP 1 is able to prevent power or ink from being wasted by a device which the user does not want to use.

### Second Embodiment

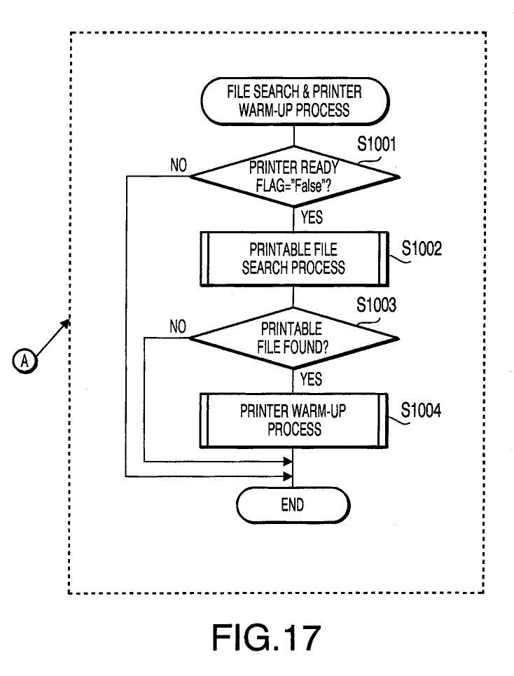

Since a second embodiment is a variation of the MFP process shown in FIG. 8, the above mentioned drawings are user for the explanations of the second embodiment. Hereafter, the feature of the second embodiment is described. FIG. 17 shows a file search and printer warm-up process according to the second embodiment. The file search and printer warm-up process is executed in place of steps S105 to S107 of the MFP process shown in FIG. 8.

In the file search and printer warm-up process, the control unit 11 judges whether the printer ready flag is “False” (S1001). If the printer ready flag is not “False” (S1001: NO), the file search and printer warm-up process terminates. If the printer ready flag is “False” (S1001: YES), the control unit 11 executes a printable file search process in step S1002.

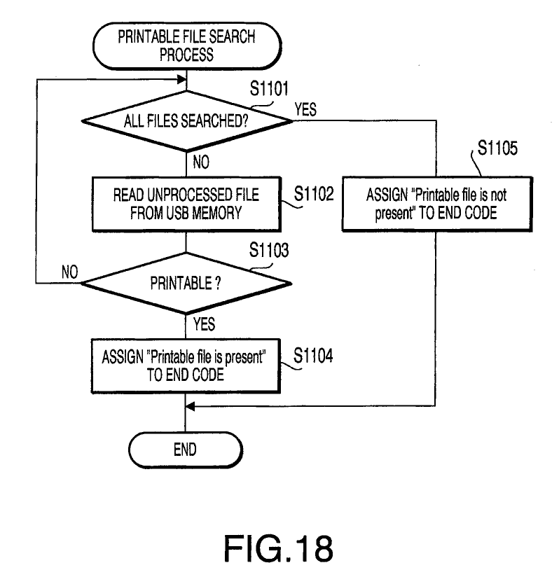

FIG. 18 shows the printable file search process. When the printable file search process is initiated, the control unit 11 judges whether all the files in the USB memory 3 have been searched (step S1101). If all the files in the USB memory 3 have not been searched (S1101: NO), the control unit 11 reads a file (i.e., a processed file) from the USB memory 3 (step S1102). Then, the control unit 11 judges whether the file obtained in step S1101 has a printable file format (step S1103).

If the file obtained in step S1101 does not have a printable file format (S1103: NO), control returns to step S1101. If the file obtained in step S1101 has a printable file format (S1103: YES), the control unit 11 assigns “a printable file is present” to the end code (step S1104). Then, printable file search process terminates.

After control returns from the printable file search process to the file search and printer warm-up process, the control unit 11 checks the end code to judge whether a printable file is present (step S1103). If a printable file is not present (S1103: NO), the file search and printer warm-up process terminates. If a printable file is present (S1103: YES), the control unit 11 executes the LB printer warm-up process or the IJ printer warm-up process depending on the type of the recording unit 12 (step S1004). Then, the file search and printer warm-up process terminates.

According to the second embodiment, it is possible to cause the recording unit 12 to execute the warm-up process in response to existence of a printable file in the USB memory 3 inserted into the USB host interface 16. In other words, it is possible to prevent the recording unit 12 from executing the warm-up process regardless of the fact that there is no printable file in the USB memory 3. Therefore, the MFP 1 prevents the power and ink from being wasted.

### Third Embodiment

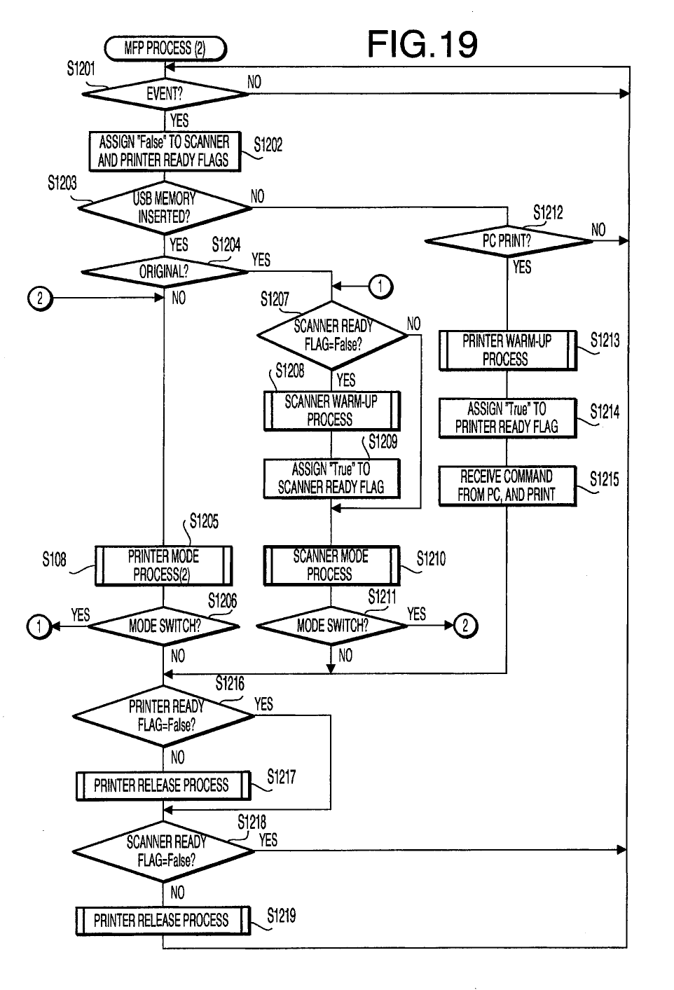

Since a third embodiment is a variation of the MFP process shown in FIG. 8, the above mentioned drawings are used for the explanations of the third embodiment. FIG. 19 shows a MFP process according to the third embodiment. Hereafter, the feature of the third embodiment is described, explanations for the steps which are substantially the same as those in the MFP process shown in FIG. 8 will not be repeated for the sake of simplicity.

When the MFP process shown in FIG. 19 is initiated, the control unit 11 judges whether an event exists (step S1201). The control unit 11 waits until an event is detected (S1201: NO). If an event is detected (S1201: YES), the control unit 11 assigns “False” to the scanner ready flag and the printer ready flag (step S1202). Then, the control unit judges whether the event corresponds to the insertion of the USB memory 3 to the USB host interface 16 (step S1203). IF the event corresponds to the insertion of the USB memory 3 to the USB host interface 16 (S1203: YES), control proceeds to step S1207 where the control unit 11 judges whether an original is placed on the original based of the reading unit 13.

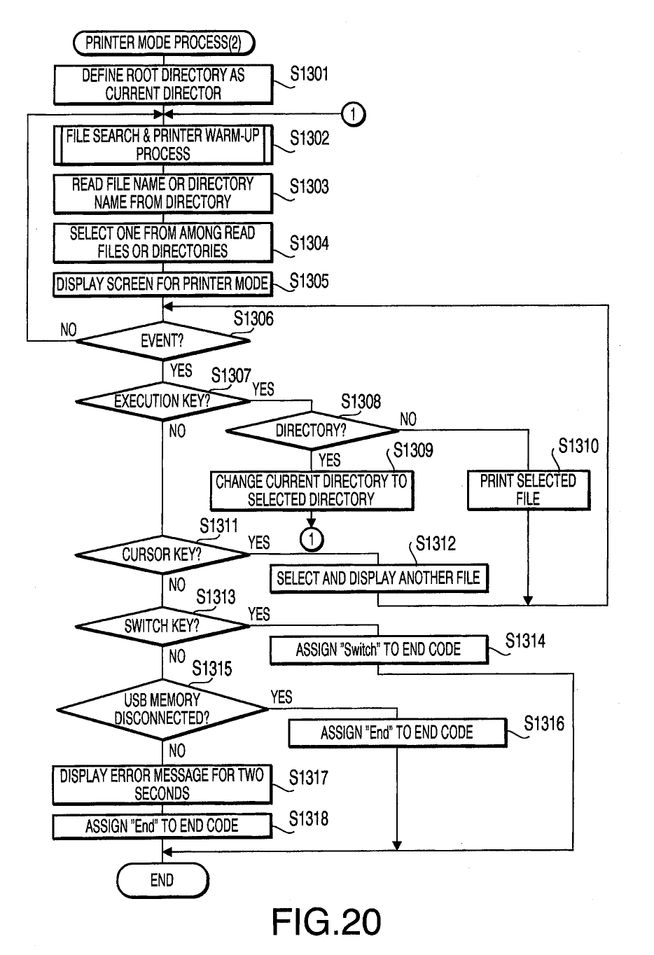

If an original is not found (S1204: NO), the control unit 11 executes a printer mode process (2) in step S1205. FIG. 20 shows the printer mode process (2). In the printer mode process (2), the control unit 11 defines a root directory as a current directory (step S1301). Then, the control unit 11 executes the file search and printer warm-up process shown in FIG. 17. After the file search and printer warm-up process is finished, the control unit 11 file names and directory names in the current directory (step S1303). Then, the control unit 11 selects a file or a directory from among the files and directories obtained in step S1303 (step S1304).

For example, the control unit selects one which is found first in the directory. Then, in step S1305, the control unit 1 displays the screen for the printer mode (see FIG. 6A). next, in step S1306, the control unit 11 judges whether an event (e.g., an interruption) occurs. If no event occurs (S1306: NO), control returns to step S1302. If an event occurs (S1306: YES), the control unit 11 judges whether the event corresponds to pressing of the execution key 151 (step S1307). If the event corresponds to the pressing of the execution key 151 (S1307: YES), the control unit 11 judges whether the item currently displayed on the display 14 is a file or a directory (S1308).

If the item currently displayed on the display 14 is a directory (S1308: YES), the control unit 11 changes the current directory to the selected directory (step S1309). Then, control returns to step S1302. If the item currently displayed on the display 14 is not a directory (S1308: NO), the image corresponding to the selected file (i.e., the file currently displayed on the display 14) is printed through the recording unit 12 (step S1310). Then, control returns to step S1306. In step S1301, the control unit 11 may print words “print impossible” on a sheet of paper if the selected file is an unprintable file.

If the event does not correspond to the pressing of the execution key 151 (S1307: NO), the control unit 11 judges whether the event corresponds to pressing of the cursor key 154 (step S1311). If the event corresponds to the pressing of the cursor key 154 (S1311: YES), the control unit 11 displays another file or another directory on the display 14 as a candidate (step 1312). The selection of a file or a directory is conducted through the cursor keys 154 as in the case of step S407. Then, control returns to step S1306.

If the event does not correspond to the pressing of the cursor key 154 (S1311: NO), control proceeds to step S1313 where the control unit 11 judged whether the event corresponds to pressing of the switch key 152. If the event corresponds to the pressing of the switch key 152 (S1313: YES), the control unit 11 assigns a value “Switch” to the end code (step S1314). Then, the printer mode process (2) terminates.

If the event does not correspond to the pressing of the switch key 152 (S1313: NO), the control unit 11 judges whether the event corresponds to removal of the USB memory 3 from the USB host interface 16 (step S1315). If the event corresponds to the removal of the USB memory 3 from the USB host interface 16 (S1315: YES), the control unit 11 assigns “End” to the end code (step S1316). Then, the printer mode process (2) terminates.

If the event does not correspond to the removal of the USB memory 3 from the USB host interface 16 (S1315: NO), the control unit 11 displays an error message on the display 14 for two seconds (step S1317). Next, the control unit 11 assigns “End” to the end code (step S1318). Then, the printer mode process (2) terminates.

After the printer mode process (2) is finished, steps S1206 to S1219 are executed. Since steps S1206 to S1219 are substantially the same as steps S102 to S122 in FIG. 8, explanations thereof will not be repeated.

According to the third embodiment, it is possible to cause the recording unit 12 to execute the warm-up process in response to existence of a printable file in the USB memory 3 inserted into the USB host interface 16. In other words, it is possible to prevent the recording unit 12 from executing the warm-up process regardless of the fact that a directory not having any printable file is selected. It is possible to predict whether the print operation occurs more reliably. Therefore, the MFP 1 prevents the power and ink from being wasted.

Although the present invention has been described in considerable detail with reference to certain preferred embodiments thereof, other embodiments are possible.

For example, the above mentioned function of the MFP may be implemented on an image processing device having a printing function only or on an image processing device having a scanner function only.

In the above mentioned embodiment, the presence or absence of an original on the original based is used to select a target device for the warm-up process (see step S104 of the MFP process). However, a target device for the warm-up process may be selected in accordance with presence or absence of a file to be printed in the removal memory (USB memory). For example, the MFP may operate to select the recording unit (printer) as a target for the warm-up process if image data to be printed is stored in the removal memory, while the MFP may operate to select the reading unit (scanner) as a target for the warm-up process if no image information to be printed is stored in the removal memory.

Alternatively, a target to be subjected to the warn-up process in response to insertion of the USB memory into the MFP 1 may be designated by the user through the operation panel 20.

What is claimed is:

1. An image processing device, comprising:
an interface into which a removal storage medium can be connected;
at least one device having one of an image reading function and an image output function;
a preparation control unit configured to execute a preparation process for the at least one device so that the at least one device moves from a first state where the at least one device is not ready for operation to a second state where the at least one device is ready for operation;
an image process unit having at least one of a function of storing image data corresponding to an image obtained by the image reading function of the at least one device into the removal storage medium connected to the interface, and a function of reading image data from the removal medium connected to the interface and passing the read image data to the at least one device so that an image corresponding to the read image data is outputted by the image output function of the at least one device;
a detection unit configured to detect whether the removal storage medium is connected to the interface; and
a controller configured to cause the preparation control unit to move the at least one device to the second state in response to detection of insertion of the removal medium into the interface by the detection unit.

2. The image processing device according to claim 1, wherein:
the at least one device comprises a device having the image reading function and a device having the image output function;
the image processing device further comprises a selection unit configured to select one of the at least one device to be moved to the second state; and
the controller causes the preparation control unit to move a device selected by the selection unit to the second state in response to detection of insertion of the removal medium into the interface by the detection unit.

3. The image processing device according to claim 2, wherein:
the selection unit selects one of the at least one device based on a status of the device having the image reading function.

4. The image processing device according to claim 2, wherein:
the selection unit selects the device having the image output function if the removal storage medium connected to the interface has a predetermined type of data.

5. The image processing device according to claim 2, wherein:
the removal storage medium is accessible through a file system having a directory structure;
the image processing device comprises a directory designation unit configured to designate a directory of the removal storage medium to be accessed;
the selection unit selects the device having the image output function if a designated directory of the removal storage medium designated by the directory designation unit has a predetermined type of data.

6. The image processing device according to claim 2, wherein:
the device having the image output function is a recording device configured to record an image on a recording medium; and
the selection unit selects the recording device as a device to be moved to the second state.

7. The image processing device according to claim 1, wherein:
the at least one device has at least the image output function;
the at least one device having the image output function is an electrophotographic recording device configured to form an image on a recording medium by forming firstly a toner image on the recording medium and then heat fixing the toner image through a fixing unit;
the preparation control unit executes the preparation process for the electrophotographic recording device by heating the fixing unit to have a predetermined temperature if the electrophotographic recording unit is in the first state where the fixing unit is not at the predetermined temperature.

8. The image processing device according to claim 1, wherein:
the at least one device has at least the image output function;
the at least one device having the image output function is an inkjet recording device configured to form an image on a recording medium by ejecting ink fro nozzles;
the preparation control unit executes the preparation process for the inkjet recording device by cleaning the nozzles if the inkjet recording device is in the first state where the nozzles have not been cleaned.

9. The image processing device according to claim 2, further comprising an original detection unit configured to detect presence or absence of an original on which an image to be read is formed;
wherein:
the device having the image reading function is an image reading device configured to read an image from the original; and
the selection unit selects the image reading device as a device to be moved to the second state if the original detection unit detects that the original is present.

10. The image processing device according to claim 1, wherein:
the at least one device has at least the image reading function;
the at least one device having the image reading function is an image reading device configured to read information from a target by illuminating the target using a lamp and then obtaining the information based on light reflected from the target; and
the preparation control unit executes the preparation process for the image reading device by waiting until an amount of light of the lamp is stabilized from activation of the lamp if the image reading device is in the first state where the lamp is off or the amount of light of the lamp is not stabilized.

11. The image processing device according to claim 1, further comprising a releasing unit configured to execute a release process for the at least one device so that the at least one device moves from the second state to the first state,
wherein the controller causes the releasing unit to move the at least one device to the first state in response to completion of an operation of the at least one device.

12. The image processing device according to claim 1, further comprising a releasing unit configured to execute a release process for the at least one device so that the at least one device moves from the second state to the first state,
wherein the controller causes the releasing unit to move the at least one device to the first state in response to detection of disconnection of the removal storage medium from the interface by the detection unit.

13. A method for warming-up an image processing device including at least one device having one of an image reading function and an image output function, comprising:
a detecting step of detecting whether a removal storage medium is connected to an interface of the image processing device; and
a preparation step of moving the at least one device from a first state where the at least one device is not ready for operation to a second state where the at least one device is ready for operation, in response to detection of insertion of the removal medium into the interface.

14. The method according to claim 1, wherein:
the at least one device comprises a device having the image reading function and a device having the image output function,
the method further comprises a selection step of selecting one of the at least one device to be moved to the second state; and
in the preparation step, the device selected by the selection step is moved to the second state in response to detection of insertion of the removal medium into the interface.

15. The method according to claim 14, wherein:
in the selection step, one of the at least one device is selected based on a status of the device having the image reading function.

16. The method according to claim 14, wherein:
in the selection step, the device having the image output function is selected if the removal storage medium connected to the interface has a predetermined type of data.

17. The method according to claim 14, wherein:
the removal storage medium is accessible through a file system having a directory structure;
the method further comprises a directory designation step of to designating a directory of the removal storage medium to be accessed; and
in the selection step, the device having the image output function is selected if a designated directory of the removal storage medium has a predetermined type of data.

18. The method according to claim 14, wherein:
the device having the image output function is a recording device configured to record an image on a recording medium; and
in the selection step, the recording device is selected as a device to be moved to the second state.

19. The method according to claim 13, wherein:
the at least one device has at least the image output function;
the at least one device having the image output function is an electrophotographic recording device configured to form an image on a recording medium by forming firstly a toner image on the recording medium and then heat fixing the toner image through a fixing unit; and
the preparation step comprises a step of heating the fixing unit to have a predetermined temperature if the electrophotographic recording unit is in the first state where the fixing unit is not at the predetermined temperature.

20. The method according to claim 13, wherein:
the at least one device has at least the image output function;
the at least one device having the image output function is an inkjet recording device configured to form an image on a recording medium by ejecting ink fro nozzles; and
the preparation step comprises a step of cleaning the nozzles if the inkjet recording device is in the first state where the nozzles have not been cleaned.

21. The method according to claim 14, further comprising an original detection step of detecting presence or absence of an original on which an image to be read is formed;
wherein:
the device having the image reading function is an image reading device configured to read an image from the original; and
in the selection step, the image reading device is selected as a device to be moved to the second state if the presence of the original is detected by the original detection step.

22. The method according to claim 13, wherein:
the at least one device has at least the image reading function;
the at least one device having the image reading function is an image reading device configured to read information from a target by illuminating the target using a lamp and then obtaining the information based on light reflected from the target; and
the preparation step comprises a step of waiting until an amount of light of the lamp is stabilized from activation of the lamp if the image reading device is in the first state where the lamp is off or the amount of light of the lamp is not stabilized.

23. The method according to claim 13, further comprising a releasing step of moving the at least one device from the second state to the first state in response to completion of an operation of the at least one device.

24. The method according to claim 13, further comprising a releasing step of moving the at least one device from the second state to the first state in response to detection of disconnection of the removal storage medium from the interface.

25. A computer readable medium having computer readable instruction stored thereon, which, when executed by a processor of an image processing device including at least one device having one of an image reading function and an image output function, configures the processor to perform the steps of:
detecting whether a removal storage medium is connected to an interface of the image processing device; and
moving the at least one device from a first state where the at least one device is not ready for operation to a second state where the at least one device is ready for operation, in response to detection of insertion of the removal medium into the interface.
